(19) United States
(12) Patent Application Publication
(10) Pub. No.: US 2010/0198426 A1
(43) Pub. Date: Aug. 5, 2010

(54) PARTITION, CONTROL DEVICE AND METHOD, PROGRAM, AND RECORDING MEDIUM

(75) Inventors: Tetsujiro Kondo, Tokyo (JP); Junichi Shima, Kanagawa (JP); Akihiko Arimitsu, Kanagawa (JP); Takuro Ema, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/671,058

(22) PCT Filed: Aug. 8, 2008
(86) PCT No.: PCT/JP2008/064279

§ 371 Date: Jan. 28, 2010

(30) Foreign Application Priority Data
Aug. 8, 2007 (JP) 2007 206002

(51) Int. Cl. G05D 1/02; E04B 1/82; E04B 1/343

(52) U.S. Cl. 700/302; 181/287

(57) ABSTRACT

A partition, a control device and method, a program, and a recording medium that can enhance the acoustic effect. Partitions are set in a room beforehand. The partitions are movable along a guide provided in a ceiling. In the room, furniture and a speaker are set. When sound from the speaker is reflected by the furniture and the reflected sound is given to a user, the acoustic effect is lessened. Accordingly, the partitions are moved in front of the furniture. Further, the partitions are moved so as to be symmetrically arranged with respect to the speaker. The movement of the partitions can produce an acoustic space in which the reflected sound is uniform. The present invention is applicable to a partition that enhances the acoustic effect.

### TECHNICAL FIELD

The present invention relates a partition, a control device and method, a program, and a recording medium, and more particularly, to a partition, a control device and method, a program, and a recording medium that can enhance the acoustic effect.

### BACKGROUND ART

Patent Document 1 mentions that reflection and a diffusion area of an acoustic signal are controlled by changing the shape of an actuator mounted on a wall surface when an acoustic beam is applied by an array speaker.

Patent Document 2 mentions that the room size can be arbitrarily changed by attaching partition panels to horizontal bars crossing each other.

Patent Document 3 describes a rotatable moving wall. One sentence in the document says that the acoustic effect of an acoustic room is enhanced by rotating a panel of the moving wall to an appropriate angle.

Patent Document 1: Japanese Unexamined Patent Application Publication No. 2006-106611

Patent Document 2: Japanese Unexamined Patent Application Publication No. 2000-045431

Patent Document 3: Japanese Patent No. 3682616

### DISCLOSURE OF INVENTION

### Problems to be Solved by the Invention

In Patent Document 1, it is conceivable that high accuracy is required to control the actuator. Further, while primary reflection from the array speaker is controlled, since other reflections are not considered, it is conceivable that the acoustic effect is lessened by the other reflections.

Patent Document 2 does not describe enhancement of the acoustic effect.

Patent Document 3 mentions that the acoustic effect can be enhanced by rotating the rotatable moving wall to an appropriate angle, but does not describe a specific method for enhancing the acoustic effect. Therefore, it is impossible from Patent Document 3 to read how the panel is rotated to the appropriate angle and how the acoustic effect is enhanced by the rotation.

In a case in which a panel or the like is used as a partition, there has been a demand that the partition have not only a function as a partition, but also other functions. For example, there has been a demand to use the partition in order to enhance the acoustic effect.

The present invention has been made in view of such a circumstance, and aims to enhance the acoustic effect and to provide other functions of a partition or the like.

### Means for Solving the Problems

A partition according to an aspect of the present invention is a partition including moving means, and is set at each predetermined position that enhances an acoustic effect of sound output from an audio output device.

The audio output device can be provided in a space formed by the partition, and the partition can be set in a manner such that a distance from the audio output device to a predetermined side of the space is equal to a distance from the audio output device to the other side opposing the predetermined side.

The partition can be set in a manner such that the sound output from the audio output device is reflected a plurality of times.

One surface of the partition can be a first surface formed of a material that absorbs sound, and the other surface of the partition can be a second surface formed of a material that reflects sound. The partition can be set in a manner such that the first surface points toward the audio output device when being set at a position to absorb the sound from the audio output device, and can be set in a manner such that the second surface points toward the audio output device when being set at a position to reflect the sound from the audio output device.

The audio output device can output the sound in a beam form. The partition can be set in a manner such that the second surface points toward the audio output device when being set at a position where the sound output in the beam form impinges, and can be set in a manner such that the first surface points toward the audio output device when being set at another position.

The audio output device can output the sound radially. The partition can be set in a manner such that the second surface points toward the audio output device when being set at a position where the radially output sound impinges, and can be set in a manner such that the first surface points toward the audio output device when being set at another position.

The partition can be set in a manner such that a surface which forms the partition and which is formed of a material that absorbs sound points toward the audio output device.

The partition can include the audio output device, and can be set as an audio output device that forms a surround-sound system.

The moving means can be a wheel fixed to a lower side of the partition, and the partition can further include tension fixing means that fixes the partition by contact with a ceiling.

The partition can further include second tension fixing means that fixes the partition by contact with a floor surface.

The partition can further include a rotation shaft to be loosely fitted in holes provided in the floor surface and the ceiling.

The partition according to the aspect of the present invention is moved to and set at a position that enhances the acoustic effect.

A first control device according to an aspect of the present invention includes a control unit configured to control a setting position of a partition to be set at a predetermined position that enhances an acoustic effect of sound output from an audio output device. The control unit calculates an angle formed between a straight line connecting the audio output device and the partition, and a wall surface of a room where the audio output device is set, and controls setting of the partition so that a normal to the partition is located to bisect the angle.

A first control method according to an aspect of the present invention is a control method of a control unit configured to control a setting position of a partition to be set at a predetermined position that enhances an acoustic effect of sound output from an audio output device, and includes the steps of calculating an angle formed between a straight line connecting the audio output device and the partition, and a wall surface of a room where the audio output device is set and controlling setting of the partition so that a normal to the partition is located to bisect the angle.

A first program according to an aspect of the present invention is a program readable by a computer that causes a control unit to perform processing. The control unit controls a setting position of a partition to be set at a predetermined position that enhances an acoustic effect of sound output from an audio output device. The processing includes the steps of calculating an angle formed between a straight line connecting the audio output device and the partition, and a wall surface of a room where the audio output device is set and controlling setting of the partition so that a normal to the partition is located to bisect the angle.

In the first control device, method, and program according to the aspects of the present invention, the angle formed between the straight line connecting the audio output device and the partition, and the wall surface of the room where the audio output device is set is calculated, and control is exerted so that the partition is located at a position where the angle is bisected by the normal to the partition.

A second control device according to an aspect of the present invention includes a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device. When the audio output device outputs the sound in a beam form, the control unit calculates coordinates of a position on a wall surface where the sound in the beam form impinges, from coordinates where the audio output device is set and a beam emission angle at which the sound in the beam form is output. The control unit exerts control so that the second surface points toward the audio output device when a partition serving as a processing target, of a plurality of partitions, is a partition on the coordinates of the position on the wall surface, and exerts control so that the first surface points toward the audio output device when the partition serving as the processing target is not the partition on the coordinates of the position on the wall surface.

A second control method according to an aspect of the present invention is a control method of a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device. The control method includes the steps of calculating coordinates of a position on a wall surface where the sound in a beam form impinges, from coordinates where the audio output device is set and a beam emission angle at which the sound in the beam form is output when the audio output device outputs the sound in the beam form, exerting control so that the second surface points toward the audio output device when a partition serving as a processing target, of a plurality of partitions, is a partition on the coordinates of the position on the wall surface, and exerting control so that the first surface points toward the audio output device when the partition serving as the processing target is not the partition on the coordinates of the position on the wall surface.

A second program according to an aspect of the present invention is a program readable by a computer that causes a control unit to perform processing. The control unit controls a setting position of a partition which has one surface serving as a first surface formed of a material that absorbs sound and the other surface serving as a second surface formed of a material that reflects sound and which is set at a predetermined position that enhances an acoustic effect of sound output from an audio output device. The processing includes the steps of calculating coordinates of a position on a wall surface where the sound in a beam form impinges, from coordinates where the audio output device is set and a beam emission angle at which the sound in the beam form is output when the audio output device outputs the sound in the beam form, exerting control so that the second surface points toward the audio output device when a partition serving as a processing target, of a plurality of partitions, is a partition on the coordinates of the position on the wall surface, and exerting control so that the first surface points toward the audio output device when the partition serving as the processing target is not the partition on the coordinates of the position on the wall surface.

In the second control device, method, and program according to the aspects of the present invention, when the audio output device outputs the sound in a beam form, the coordinates of the position on the wall surface where the sound in the beam form impinges are calculated from the coordinates where the audio output device is set and the beam emission angle at which the sound in the beam form is output, and control is exerted so that the surface of the partition on the coordinates for reflecting the sound points toward the audio output device.

A third control device according to an aspect of the present invention includes a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device. When the audio output device radially outputs the sound, coordinates of a position on a wall surface where the radially output sound impinges, from coordinates where the audio output device is set and a beam emission angle at which the radially output sound is output is calculated. Control is exerted so that the second surface points toward the audio output device when a partition serving as a processing target, of a plurality of partitions, is a partition on the coordinates of the position on the wall surface, and control is exerted so that the first surface points toward the audio output device when the partition serving as the processing target is not the partition on the coordinates of the position on the wall surface.

When exerting control so that the second surface points toward the audio output device, the control unit can calculate an angle formed between a first straight line connecting the audio output device and the partition and a second straight line connecting a user viewing/listening position to which the sound is supplied from the audio output device and the partition, and can control setting of the partition so that the second surface points in a direction in which a normal to the partition bisects the angle.

A third control method according to an aspect of the present invention is a control method of a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device. The control method includes the steps of calculating coordinates of a position on a wall surface where the radially output sound impinges, from coordinates where the audio output device is set and a beam emission angle at which the radially output sound is output when the audio output device radially outputs the sound, exerting control so that the second surface points toward the audio output device when a partition serving as a processing target, of a plurality of partitions, is a partition on the coordinates of the position on the wall surface, and exerting control so that the first surface points toward the audio output device when the partition serving as the processing target is not the partition on the coordinates of the position on the wall surface.

A third program according to an aspect of the present invention is a program readable by a computer that causes a control unit to perform processing. The control unit controls a setting position of a partition which has one surface serving as a first surface formed of a material that absorbs sound and the other surface serving as a second surface formed of a material that reflects sound and which is set at a predetermined position that enhances an acoustic effect of sound output from an audio output device. The processing includes the steps of calculating coordinates of a position on a wall surface where the radially output sound impinges, from coordinates where the audio output device is set and a beam emission angle at which the radially output sound is output when the audio output device radially outputs the sound, exerting control so that the second surface points toward the audio output device when a partition serving as a processing target, of a plurality of partitions, is a partition on the coordinates of the position on the wall surface, and exerting control so that the first surface points toward the audio output device when the partition serving as the processing target is not the partition on the coordinates of the position on the wall surface.

In the third control device, method, and program according to the aspects of the present invention, when the audio output device radially outputs the sound, the coordinates of the position on the wall surface where the radially output sound impinges are calculated from the coordinates where the audio output device is set and the beam emission angle at which the radial sound is output, and control is exerted so that the surface of the partition on the coordinates for reflecting the sound points toward the audio output device.

### ADVANTAGEOUS EFFECTS

According to the aspects of the present invention, a function of a partition and the like can be realized. Further, the acoustic effect in the setting room can be enhanced.

### BRIEF DESCRIPTION OF DRAWINGS

FIG. 1 is view showing a structure of an embodiment of a partition to which the present invention is applied.

FIG. 2 is a view showing another structure example of a partition.

FIG. 3 is a view showing a further structure example of a partition.

FIG. 4 is a view explaining setting of partitions in the room.

FIG. 5 is a view showing a further structure example of a partition.

FIG. 6 is a view showing a further structure example of a partition.

FIG. 7 is a view explaining setting of partitions in the room.

FIG. 8 is a view explaining setting of partitions in the room.

FIG. 9 is a view explaining setting of partitions in the room.

FIG. 10 is a view showing a configuration example of a processing unit.

FIG. 11 is a flowchart explaining processing of the processing unit.

FIG. 12 is a view explaining how to set the angle.

FIG. 13 is a view explaining setting of partitions in the room.

FIG. 14 is a view showing a further structure example of a partition.

FIG. 15 is a view explaining setting of partitions in the room.

FIG. 16 is a view showing a configuration example of a processing unit.

FIG. 17 is a flowchart explaining processing of the processing unit.

FIG. 18 is a view explaining setting of partitions in the room.

FIG. 19 is a view explaining setting of partitions in the room.

FIG. 20 is a view showing a configuration example of a processing unit.

FIG. 21 is a flowchart explaining processing of the processing unit.

FIG. 22 is a flowchart explaining how to set the angle.

FIG. 23 is a view showing a structure example of a partition speaker apparatus.

FIG. 24 is a view explaining setting of partitions in the room.

FIG. 25 is an explanatory view of a recording medium.

### EXPLANATION OF REFERENCE NUMERALS

11 partition, 21 base, 22 wheel, 23 tension fixing portion, 24 panel, 41 partition, 51 panel, 52 tension fixing portion, 53 tension fixing portion, 61 rotation shaft, 81 wall, 82 hole, 101 partition, 111 panel, 112 wheel, 121 ceiling, 122 guide, 131 rotation shaft, 132 beam, 151 furniture, 152 speaker, 153 user, 181 angle calculation unit 181, 182 angle calculation unit, 191 curtain, 201 partition, 211 panel, 212 panel, 221 speaker, 231 reflection-coordinates calculation unit, 232 coordinates calculation unit, 233 room-state storage unit, 251 speaker, 281 rotating-partition determining unit, 282 rotation-angle calculation unit, 283 room-state storage unit, 311 partition speaker apparatus, 323 wheel, 324 frame, 325 plate, 331 vibrating material, 341 vibrator, 342 vibrator, 343 vibrator, 361 projector

### BEST MODES FOR CARRYING OUT THE INVENTION

Embodiments of the present invention will be described below with reference to the drawings.

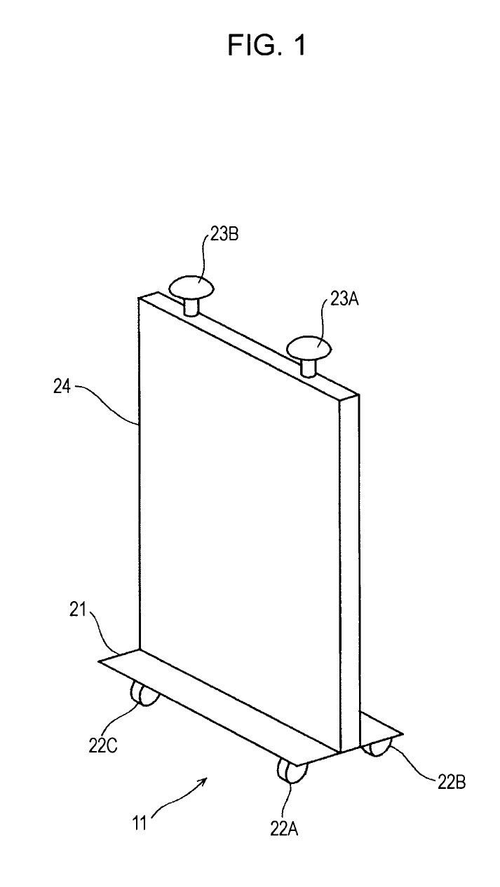

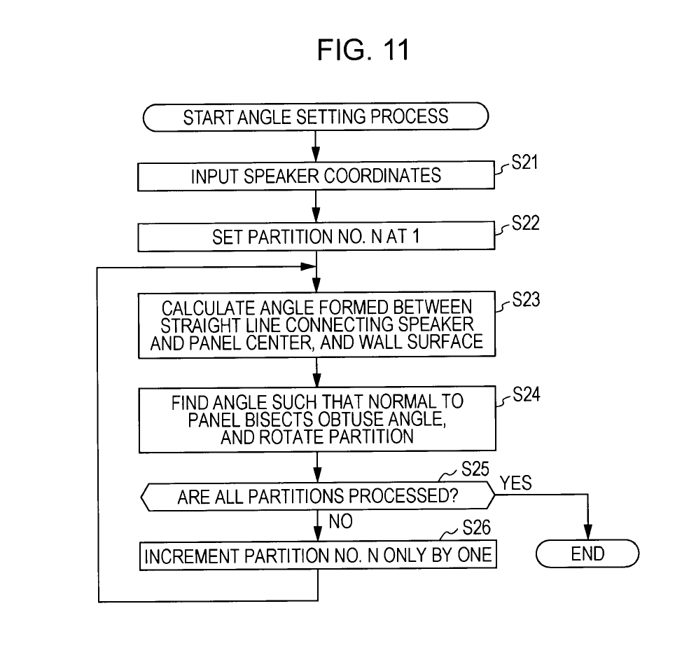

FIG. 1 is a view of a partition according to an embodiment of the present invention. A partition 11 shown in FIG. 11 includes a base 21, wheels 22A to 22D, tension fixing portions 23A and 23B, and a panel 24.

The base 21 is formed of a material that can ensure a sufficient strength to support the panel 24, for example, metal such as iron, aluminum, magnesium, or titanium. The wheels 22A to 22D (the wheel 22D is not shown) are respectively provided at four corners of a lower side of the base 21. The panel 24 is fixed to an upper side of the base 21, for example, by welding, and the panel 24 stands upright on the base 21. Further, the tension fixing portions 23A and 23B are fixed to an upper side of the panel 24. The tension fixing portions 23A and 23B are movable in the up-down direction.

For example, when the partition 11 set in the room is pushed by the user, it is moved in the pushing direction by rotations of the wheels 22A to 22D on the floor surface. Further, the heights of the tension fixing portion 23A and the tension fixing portion 23B are adjusted at a destination so that the tension fixing portions 23A and 23B come into contact with the ceiling, whereby the tension fixing portions 23A and 23B support the partition 11 by contact with the ceiling.

That is, the user can move the partition 11 to a desired position, and can fix and set the partition 11 thereat.

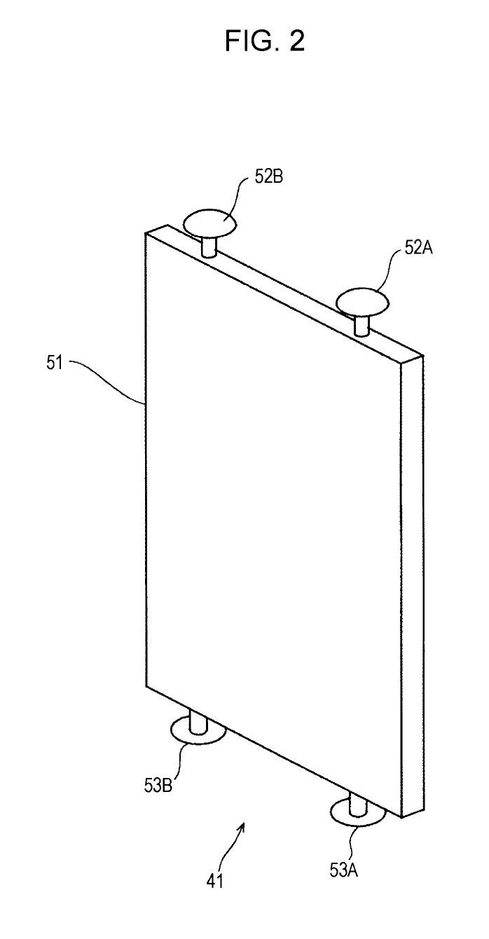

A description will be given of another structure of a partition that can be moved to a desired position and fixed and set at the moving position by the user. FIG. 2 is view of a partition having another structure. A partition 41 shown in FIG. 2 includes a panel 51, tension fixing portions 52A and 52B, and tension fixing portions 53A and 53B.

The tension fixing portions 52A and 52B are fixed to an upper side of the panel 51. The tension fixing portions 53A and 53B are fixed to a lower side of the panel. The tension fixing portions 52A, 52B, 53A, and 53B are movable in the up-down direction. Although not shown in FIG. 2, wheels 22A to 22D and a base 21 for fixing the wheels may be provided, similarly to the partition 11 shown in FIG. 1.

The partition 41 is moved to a setting place desired by the user. The heights of the tension fixing portion 52A and the tension fixing portion 52B are adjusted at the moving place so that the tension fixing portions 52A and 52B come into contact with the ceiling, whereby the tension fixing portions 52A and 52B support the partition 41 by contact with the ceiling. Further, the heights of the tension fixing portion 53A and the tension fixing portion 53B are adjusted so that the tension fixing portions 53A and 53B come into contact with the floor surface, whereby the tension fixing portions 53A and 53B support the partition 41 by contact with the floor surface.

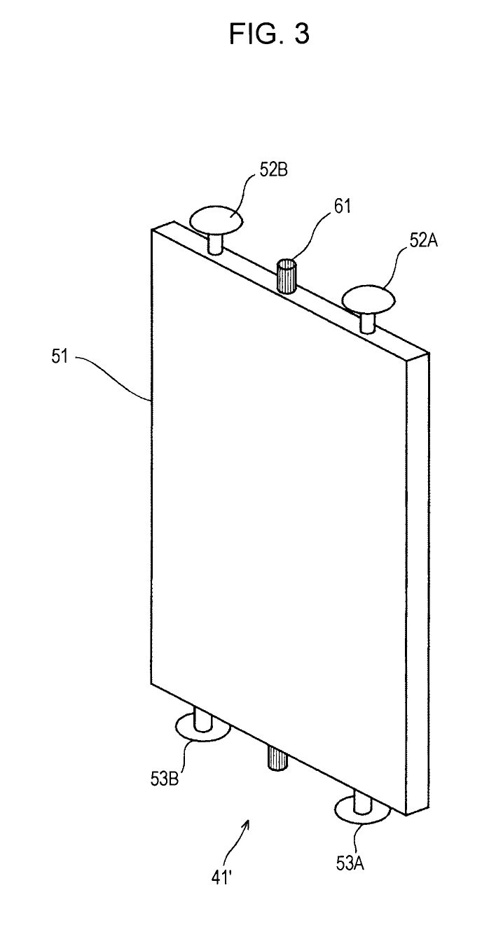

The user can move the partition 41 to a desired place, and can fix the partition 41 at a desired angle at that position. Further, as shown in FIG. 3, a structure having a rotation shaft may be adopted, in which, for example, the rotation shaft is inserted in a hole provided in the floor surface, the partition 41 is temporarily fixed, and the desired angle is then adjusted finely. Such a partition 41′ (an apostrophe (') is added for distinction from the partition 41 shown in FIG. 2) will be described with reference to FIG. 3.

The partition 41′ shown in FIG. 3 has a structure obtained by adding a rotation shaft 61 to the partition 41 shown in FIG. 2. The rotation shaft 61 is provided at almost the centers of short sides (lateral sides) of a panel 51, is fixed to have a predetermined length on an upper side of the panel 51, and is fixed to have a predetermined length on a lower side of the panel 51. The rotation shaft 61 may protrude up and down by penetrating the panel 51, or may be fixed to each of the upper and lower sides, for example, by welding without penetrating the panel 51.

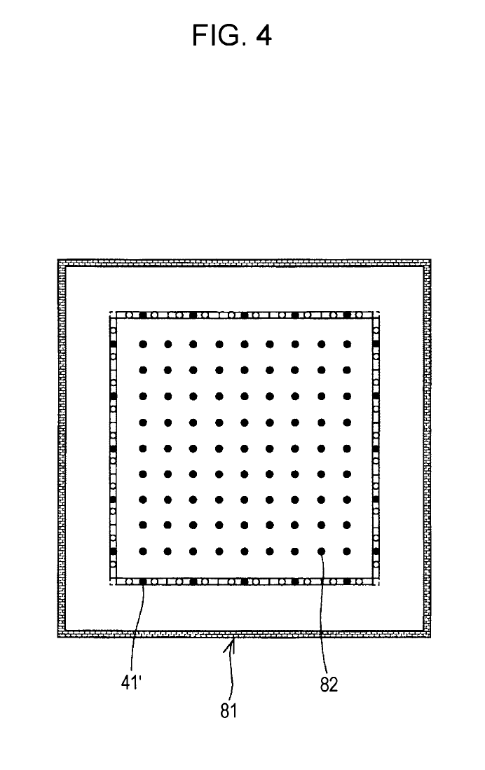

For example, the partition 41′ provided with such a rotation shaft 61 is set in a room shown in FIG. 4. The room shown in FIG. 4 is surrounded by a wall 81, and holes 82 are provided in the floor surface and the ceiling. While the room is surrounded by the wall in the description, a normal room has a door, a window, etc., and, in actuality, the partition 41′ is set in consideration of the door, the window, etc. Here, for convenience of explanation, the description will be continued with only the wall illustrated. While the holes 82 are provided at opposing positions on the floor surface and the ceiling, the description will be continued assuming that the holes shown in FIG. 4 and so on are provided in the floor surface.

The partition 41′ is moved to a setting place desired by the user, and the rotation shaft 61 is inserted in the holes 82 at the place. By inserting the rotation shaft 61 in the hole 82 provided on the floor surface and the hole 82 provided in the ceiling, the partition 41′ is set temporarily. Since the tension fixing portions 52A and so on are not tensed in this temporary setting state, the panel 51 of the partition 41′ can be rotated on the rotation shaft 61. Further, the rotation shaft 61 is loosely fitted in the holes 82 so as to enable rotation on the rotation shaft 61.

In the temporary setting state, the user rotates the panel 51 to a desired angle. When the desired angle is reached, the user adjusts the heights of the tension fixing portion 52A and the tension fixing portion 52B so that the tension fixing portions 52A and 52B come into contact with the ceiling. When the heights are adjusted, the tension fixing portion 52A and the tension fixing portion 52B come into contact with the ceiling and support the partition 41′. Further, the heights of the tension fixing portion 53A and the tension fixing portion 53B are adjusted so that the tension fixing portions 53A and 53B come into contact with the floor surface, whereby the tension fixing portions 53A and 53B come into contact with the floor surface and support the partition 41′.

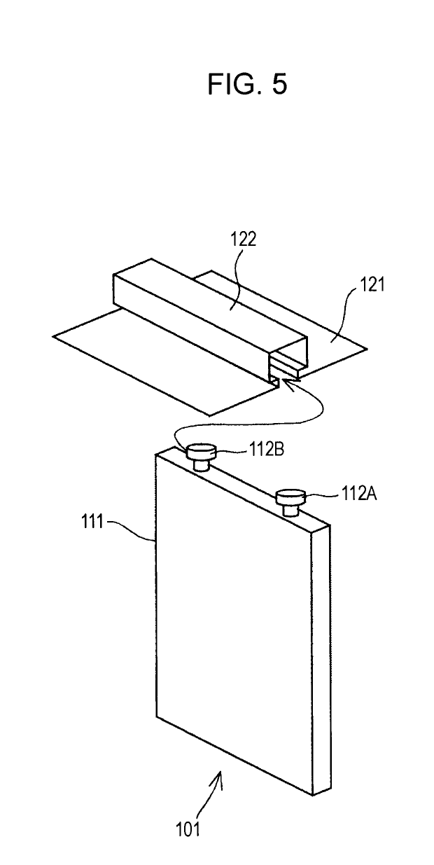

FIG. 5 is a view showing a further structure of a partition. A partition 101 shown in FIG. 5 is suspended from the ceiling. The partition 101 is supported by fitting a wheel 112A and a wheel 112B in a guide 122 provided in a ceiling 121.

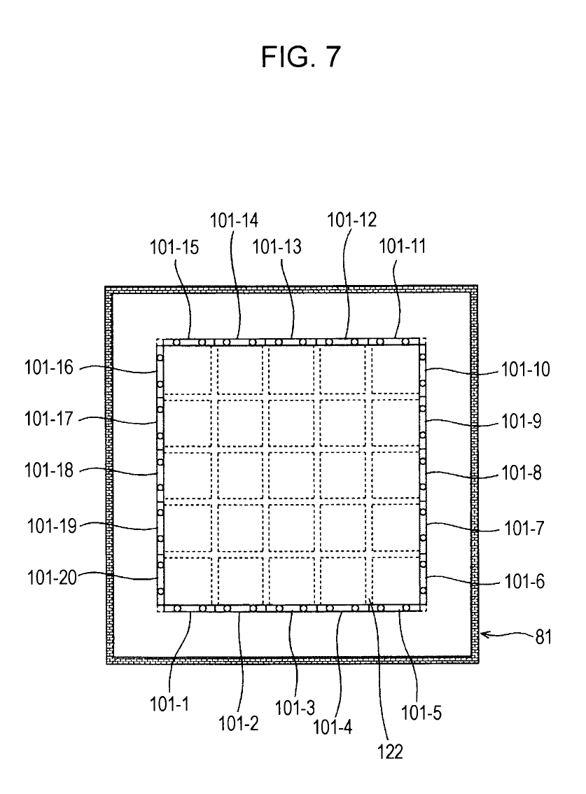

The partition 101 includes a panel 111 and the wheels 112A and 112B. The wheel 112A and the wheel 112B are fixed to the panel 111. As will be described below with reference to FIG. 7, since the guide 122 is provided in the vertical and horizontal directions in the ceiling 121 of the room, the partition 101 can move in the room along the guide 122.

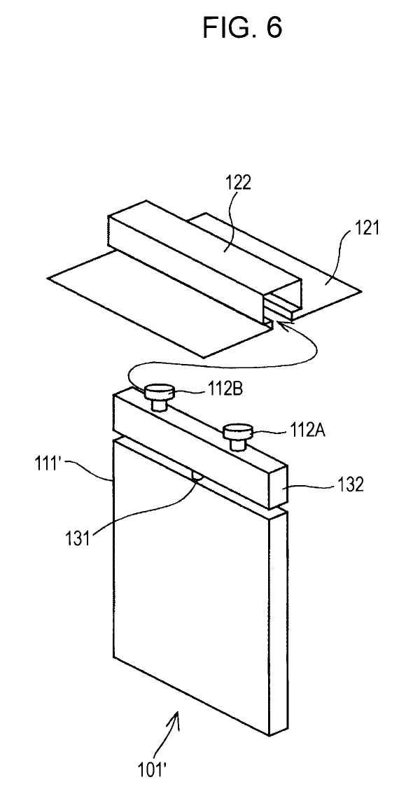

FIG. 6 is a view showing a further structure of a partition based on the structure of the partition 101 shown in FIG. 5. A partition 101′ shown in FIG. 6 has a structure obtained by adding a rotation shaft 131 to the partition 101 shown in FIG. 5. By adding the rotation shaft 131, a beam 132 is further added.

That is, in the partition 101′ shown in FIG. 6, a panel 111′ and the beam 132 are connected via the rotation shaft 131, and the panel 111′ is rotatable relative to the beam 132. A wheel 112A and a wheel 112B are fixed to an upper side of the beam 132. Similarly to the partition 101 shown in FIG. 5, the partition 101′ is supported by fitting the wheel 112A and the wheel 112B in a guide 122 provided in a ceiling 121.

The partition 101′ shown in FIG. 6 can, of course, be moved along the guide 122 to a desired position, and can be rotated at the moving position. Accordingly, for example, when pointing the panel 111′ of the partition 101′ in a desired direction, the user can finely adjust the direction.

While the partition 11 shown in FIG. 1, the partition 41 shown in FIG. 2, the partition 41′ shown in FIG. 3, the partition 101 shown in FIG. 5, or the partition 101′ shown in FIG. 6 has been described as the structure of the partition, any of the structures can be applied to the following embodiment. Taking the partition 101 shown in FIG. 5 as an example, the following description will be continued.

The partition 101 shown in FIG. 5 is set in a room shown in FIG. 7. The room shown in FIG. 7 is surrounded by a wall 81, and the partition 101 is installed therein. In FIG. 7, a plurality of partitions 101 are set to form the same shape as that of the room. Guides 122 are provided in the ceiling of the room. In FIG. 7, the guides 122 are shown by dotted lines. While the guides 122 are regularly arranged in the vertical and horizontal directions in the room in the example shown in FIG. 7, this does not mean that arrangement is limited to such an arrangement.

For example, the guides 122 may include portions arranged in a curved shape. Without being regularly arranged, the larger number of guides 122 may be arranged on one side of the room (the guides 122 are arranged at a short distance from one another) and the smaller number of guides 122 may be arranged on the other side (the guides 122 are arranged at a long distance from one another). The arrangement of the guides 122 can be appropriately determined in consideration of the shape of the room, the usage of the partitions 101, etc.

In the example shown in FIG. 7, partitions 101-1 to 101-20 are set in the room. Since each of the partitions 101-1 to 101-20 has a function as a partition, it functions as a partition when set in the room. Also, since the partitions 101 are movable, they can be set at the positions needed by the user. By thus using the movable partitions 101, the following can be realized.

First, a description will be given of enhancement of the acoustic effect of the room by the use of the partitions 101.

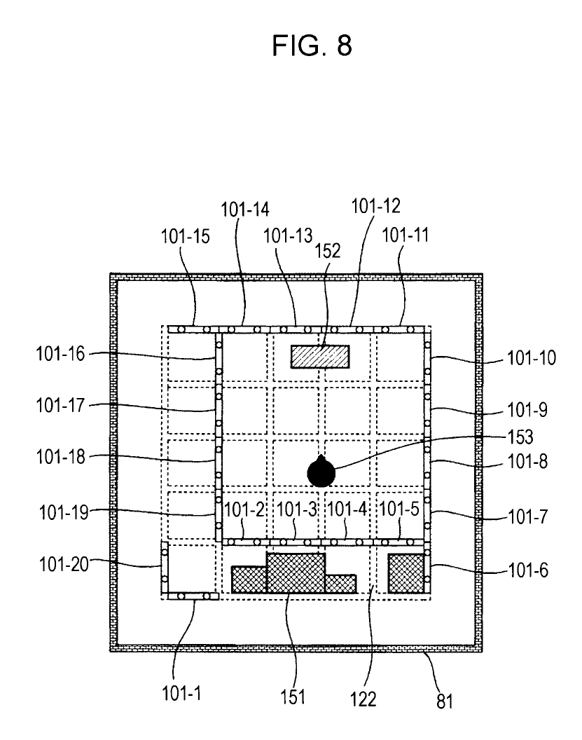

FIG. 8 is a view showing an arrangement example of the partitions 101 in consideration of enhancement of the acoustic effect. For example, the arrangement of the partitions 101 shown in FIG. 8 is realized by moving predetermined ones of the partitions 101 arranged as shown in FIG. 7.

In the room shown in FIG. 8, furniture 151 is placed. Further, FIG. 8 shows a state in which a speaker 152 is placed and a user (audience) 153 is present in front of the speaker 152. Normally, objects different from the wall, for example, furniture, a window, and a door are arranged in the room. If the partitions 101 are not set, sound from the speaker 152 impinges on a wall 81 of the room and is reflected thereby. The user 153 hears a direct sound directly heard from the speaker 152 and a reflected sound reflected by and heard from the wall 81.

In the condition shown in FIG. 8 where the furniture 151 and so on are set in the room, if the partitions 101 are not set, various kinds of reflected sounds, such as a reflected sound from the wall 81 and a reflected sound from the furniture 151, are given to the user 153. Since the wall 81 and the furniture 151 are formed of different materials, they are also different in the kind of sound reflected therefrom, for example, an easily reflected sound and an easily absorbed sound. Further, since the wall 81 and the furniture 151 are at different distances from the user 153, the reflected sound from the wall 81 and the reflected sound from the furniture 151 are different in the time taken to reach the user 153. In addition, since the furniture 151 has irregularities on its surface, it is conceivable that the direction in which the sound impinging on and reflected by the furniture 151 travels differs according to the position on the furniture 151 where the sound impinges.

It is considered that, since different reflected sounds are thus given to the user 153, the reflected sounds produce noise and this lessens the acoustic effect. Accordingly, the partitions 101 are moved and arranged, as shown in FIG. 8. That is, in the example shown in FIG. 8, the partitions 101-2 to 101-5 and the partitions 101-16 to 101-19, of the partitions 101 shown in FIG. 7, are moved.

By moving these partitions 101, the space surrounded by the partitions 101 is formed by the partitions 101 in the space surrounded by the wall 81 of the room in the example shown in FIG. 8. The space surrounded by the partitions 101 is a space that does not include a window and a door, and also does not include the furniture 151.

By thus forming the space that does not include a window and a door, it is possible to reduce the influence of reflected sounds from the objects such as the window and the door. Also, since the furniture 151 is not included in the space surrounded by the partitions 101, a reflected sound reflected from the furniture 151 can be removed. Thus, it is possible to prevent the above-described reduction of the acoustic effect due to the reflected sound from the furniture 151.

Further, referring to FIG. 8, when a straight line (not shown) passing through the speaker 152 and the user 153 is assumed, the partitions 101 are symmetrically arranged with respect to the straight line. By moving the partitions 101 so that the partitions 101 are symmetrically arranged, the distance from the speaker 152 to a predetermined partition 101 can be made equal to the distance from the speaker 152 to a partition 101 opposing the predetermined partition 101. For example, the distance from the speaker 152 to the partition 101-8 is equal to the distance from the partition 101-18 opposing the partition 101-8 to the speaker 152.

By thus setting the partitions 101 so that the distances from the speaker 152 to the partitions 101 are equal, it is possible to prevent a reflected sound traveling by a different distance from being mixed in the sound transmitted to the user 153. Further, by providing the partitions 101 with a uniform reflection characteristic, a room surrounded by walls having a uniform reflection characteristic can be realized.

By thus moving the partitions 101, it is possible to prevent the acoustic effect from being lessened, for example, by the influence of the room shape and furniture.

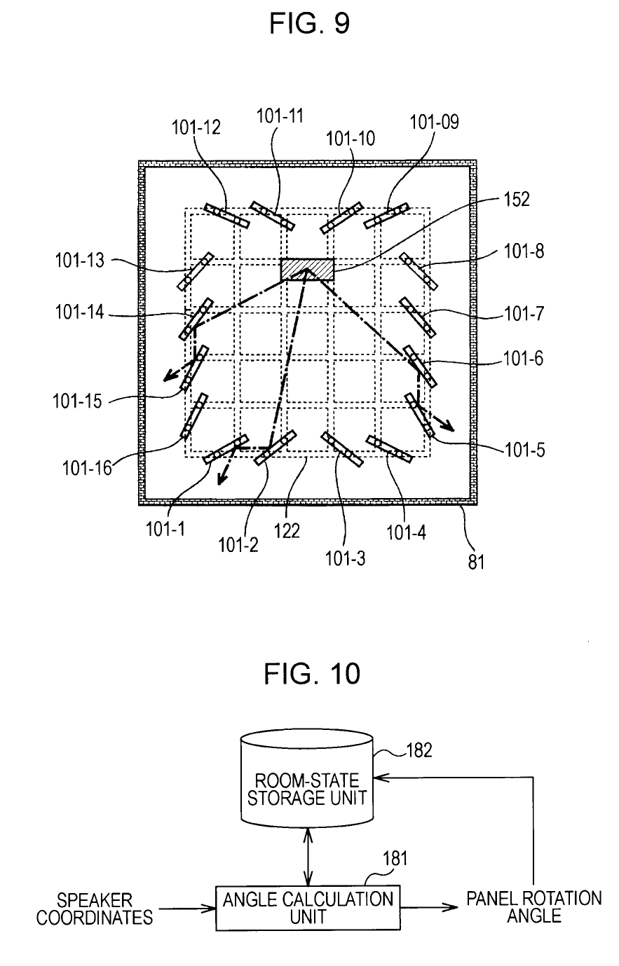

The example shown in FIG. 8 is the arrangement example of the partitions 101 made in view of sound reflection in order to prevent the acoustic effect from being lessened when a reflected sound is given to the user 153. Next, with reference to FIG. 9, a description will be given of arrangement of partitions 101 which is similarly made in view of sound reflection and which prevents reduction of the acoustic effect by inhibiting a reflected sound from being given to the user 153.

In the arrangement example of the partitions 101 in the room shown in FIG. 9, partitions 101-1 to 101-16 are arranged according to a predetermined rule. A speaker 152 is set in the room. In FIG. 9, arrows shown by one-dot chain lines indicate the traveling directions of sound from the speaker 152. For example, it is shown that sound from the speaker 152 impinges on the partition 101-6 and is reflected thereby, and that the reflected sound impinges on the partition 101-5, is reflected thereby, and travels toward a wall 81.

An audible sound normally attenuates as the propagation distance increases. Accordingly, to reduce the influence of reflected sound, the partitions 101 are arranged so that the sound from the speaker 152 is reflected a plurality of times by the partitions 101, as shown in FIG. 9. By a plurality of reflections, the propagation distance is increased and the reflected sound is attenuated. Further, when the sound impinges on the partitions 101, it is absorbed by the partitions 101 themselves, and therefore, the reflected sound attenuates at every reflection.

A description will be given of setting of the angles of the partitions 101 set in the room when the influence of the reflected sound is thus reduced by reflecting the reflected sound by the partitions 101 a plurality of times. FIG. 10 is a block diagram of a processing unit that performs processing concerning determination of the setting angles of the partitions 101. For example, the processing unit shown in FIG. 10 is provided in a control device that controls the rotations of the partitions 101. Alternatively, when the user rotates the partitions 101 on the user's own, the processing unit is used to do a simulation about the degree to which the partitions 101 should be rotated. In such a case, the simulation is done by a personal computer. For example, a part of the processing unit shown in FIG. 10 is provided as a program that is readable by the personal computer.

The processing unit shown in FIG. 10 includes an angle calculation unit 181 and a room-state storage unit 182. The angle calculation unit 181 calculates the rotation angles of the partitions 101 (partitions 101-1 to 101-16 in the example shown in FIG. 9) from the coordinates of the speaker 152 in the room and information stored in the room-state storage unit 182. The room-state storage unit 182 stores the coordinates and angles of the partitions 101-1 to 101-16. Further, the room-state storage unit 182 may store information such as the room size (layout) and the position of the furniture in the room (the position where the partitions 101 cannot be set).

Next, referring to FIG. 11 serving as a flowchart, a description will be given of processing concerning determination of the angles of the partitions 101 made by the processing unit shown in FIG. 10.

In Step S21, the coordinates of the speaker 152 are input to the angle calculation unit 181. For example, one point in the room is set at the origin (0, 0) beforehand so that a predetermined position in the room can be expressed in coordinates. In the example shown in FIG. 9, for example, the origin is set at the bottom left of the figure and on the left side of the setting position of the partition 101-1.

Here, while the partitions 101 shown in FIG. 5 that are suspended from the guide 122 of the ceiling 121 are given as an example, when the partitions 11 or the partitions 41 shown in FIG. 1 or FIG. 2 that are movable with the wheels or the like are used, the corner of the room (corner of the wall 81) is set as the origin.

In Step S22, the partition number N is set at 1. The partition number refers to a serial number assigned to each partition. For example, in the example shown in FIG. 9, the partition number N of the partition 101-1 is set at 1, and the partition number N of the partition 101-2 is set at 2. Accordingly, since the sixteen partitions 101-1 to 101-16 are set in the example shown in FIG. 9, the partition number N includes numbers 1 to 16.

When the partition number N is set at 1 in Step S22, a partition to which the partition number N of “1” is assigned (partition 101-1 in this case) is set as a processing target. Then, operations in Step S23 and subsequent steps are conducted on the partition 101 set as the processing target.

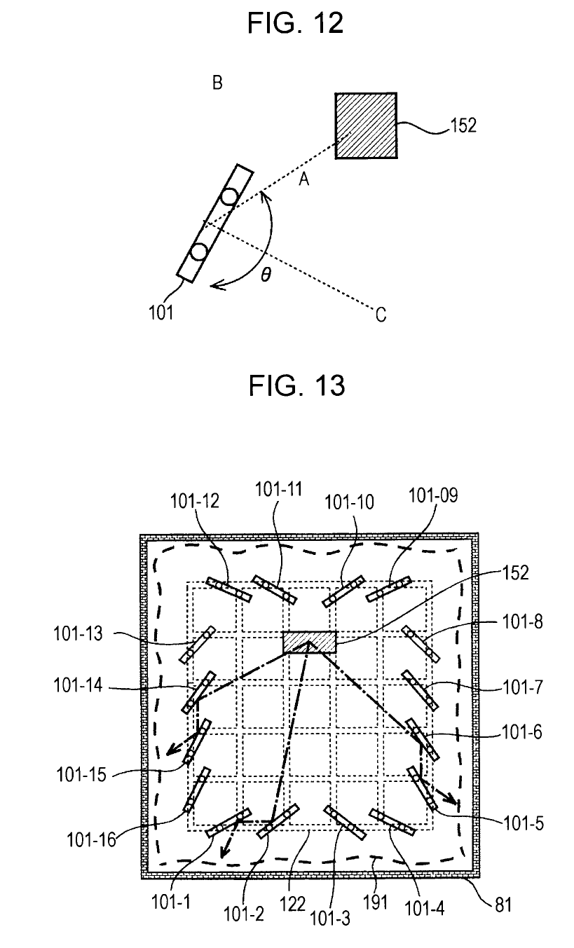

In Step S23, an angle formed between a straight line connecting the speaker 152 and the center of the panel 111 (FIG. 5) and a wall surface is calculated. This operation will be described with reference to FIG. 12. The wall surface refers to, for example, the wall 81 in FIG. 9. As shown in FIG. 12, when the angle is calculated, it is assumed that the wall surface and the center of the panel 111 are aligned. In FIG. 12, a line shown by a dotted line A is the line connecting the speaker 152 and the center of the panel 111. In this case, the angle formed between the dotted line A and the wall surface is an angle θ.

In Step S24, an angle such that a normal to the panel 111 bisects the obtuse angle is calculated, and the partition 101 is rotated to that angle. Referring to FIG. 12, the normal to the panel 111 is a dotted line C. The angle such that the dotted line C bisects the angle θ is calculated, and the partition 101 is rotated to that angle. In this way, the angle of one partition 101 is determined.

The determined angle is supplied to the room-state storage unit 182, where it is stored. In this way, the room-state storage unit 182 always stores the latest information.

In Step S25, it is determined whether or not processing of all partitions is completed. In this case, the determination is made by determining whether or not the partition number N is “16”. When it is determined in Step S25 that processing of all partitions is not completed, the process proceeds to Step S26.

In Step S26, the partition number N is incremented only by one, and the processing target is switched to the next partition 101. Then, the operations in Step S23 and subsequent steps are repeated for the partition serving as the new processing target. By repeating the operations in Steps S23 to S26, the angles of the partitions 101 set in the room are adjusted.

In contrast, when it is determined in Step S25 that processing of all partitions is completed, the process shown in FIG. 11 is finished. When the process is finished, the partitions 101 are arranged in the room, for example, as shown in FIG. 9. By thus adjusting the angles, the sound emitted from the speaker 152 is attenuated by being reflected by the partitions 101 a plurality of times, and it is therefore possible to prevent the reflected sound from being given to the user 153. Hence, it is possible to prevent the reflected sound from becoming noise, and to enhance the acoustic effect. By thus restricting reflection in the room, the occurrence of a standing wave that adversely affects a reproduced sound can be avoided.

While the reflected sound is attenuated by the sound being reflected by the partitions 101 a plurality of times, a curtain 191 may be provided inside the wall 81 and outside the partitions 101 in order to further enhance the acoustic effect, as shown in FIG. 13. It is conceivable that some sound may be reflected by the partition 101 once, but then impinges on the wall 81 without impinging on the other partitions 101. In other words, there is a possibility that some reflected sound impinges on the wall 81 without sufficiently attenuating. To absorb such a sound that impinges on the wall 81, the curtain 191 having a sound absorbing effect may be provided. In this case, since the sound repeats reflection and travels outside the inner wall (inside the outer wall (wall 81)) before impinging on the curtain 191, the sound absorbing efficiency of the curtain 191 can be enhanced.

As well, the arrangement of the partitions 101 shown in FIG. 7 and the arrangement of the partitions 101 shown in FIG. 9 will now be referred again. The twenty partitions 101-1 to 101-20 are set in the room shown in FIG. 7, and the sixteen partitions 101-1 to 101-16 are set in the room of the partitions 101 shown in FIG. 9. When the partition 101 is moved along the guide 122 provided in the ceiling 121, since the partition 101 comes to the corner of the guide 122 shaped like a lattice, it is sometimes difficult to set twenty partitions.

For this reason, sixteen partitions 101 may be set, as shown in FIG. 9. Preferably, the number of partitions 101 set in the room is the number that allows the partitions 101 to be easily moved to desired positions (the number that prevents the movement from being inhibited by interference with the other partition 101). Further, when the influence of reflected sound is reduced by reflecting sound from the speaker 152 a plurality of times, as shown in FIG. 9, preferably, the number of partitions 101 set in the room is the minimum number of partitions 101 that can be set so that the sound does not directly reach the wall 81.

Further, referring again to FIG. 9, partitions 101 are set in directions different from the direction in which the sound is emitted from the speaker 152, that is, the direction in which the user 153 is present in FIG. 9. An example in which partitions 101 are set on the sides of and behind the speaker 152 is given. Although a sound output forward from the speaker 152 is the most intense in normal cases, there is a possibility that sound will travel in the different directions or that a specific sound, such as a low-range sound, will reach the wall 81 located on the side of or behind the speaker 152. It is not desirable that such a sound is given as a reflected sound to the user 153. For example, when a low-range sound reflected from the side or from behind is given to the user 153, a low-range sound directly supplied from the speaker 152 and a low-range sound of the reflected sound are given to the user 153. This is undesirable because the balance of the sound frequency may be disturbed at the viewing/listening position.

Accordingly, to reduce such a sound, partitions on the sides and on the back side, for example, the partitions 101 -8 to 101-13 are provided in FIG. 9 so as to reduce reflected sounds traveling toward the sides and back of the speaker 152 and to thereby enhance the acoustic effect of the room. When the partitions 101 on the sides of and behind the speaker 152 are set in the room in this way, the angles of the side and back partitions 101 are determined according to the process in the flowchart of FIG. 11, similarly to the above.

In the above-described embodiment, it has been mentioned that the acoustic effect is enhanced by reflecting the sound by the partitions 101. Next, a description will be given of an embodiment used to enhance the acoustic effect by reflecting sound by partitions 101 and also to enhance the acoustic effect by absorbing sound by the partitions 101.

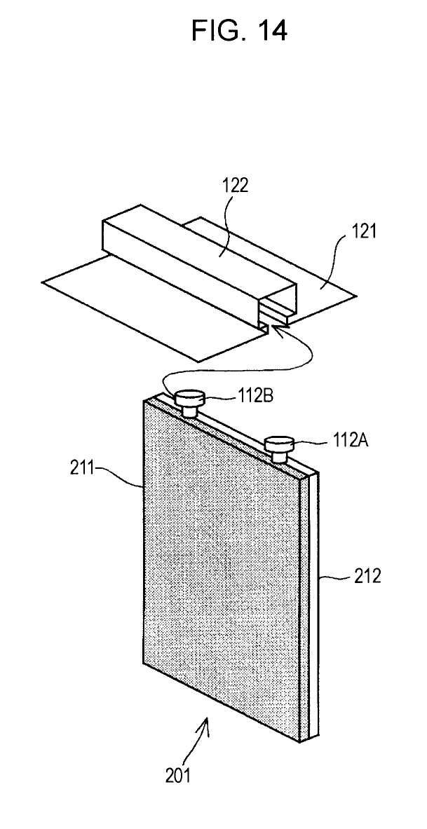

FIG. 14 is a view showing a further structure example of a partition. Similarly to the partition 101 shown in FIG. 5, a partition 201 shown in FIG. 14 is movable along a guide 122 provided in a ceiling 121. Similarly to the partition 101, the partition 201 includes wheels 112A and 112B. On the other hand, unlike the partition 101, in the partition 201, two panels having different characteristics, that is, a panel 211 and a panel 212 form one panel. The wheel 112A and the wheel 112B are fixed to the panel.

Here, the panel 211 is a panel formed of a material having the property of absorbing sound, and the panel 212 is a panel formed of a material having the property of reflecting sound. In this way, both surfaces of the partition 201 shown in FIG. 14 are formed of materials having different reflectances.

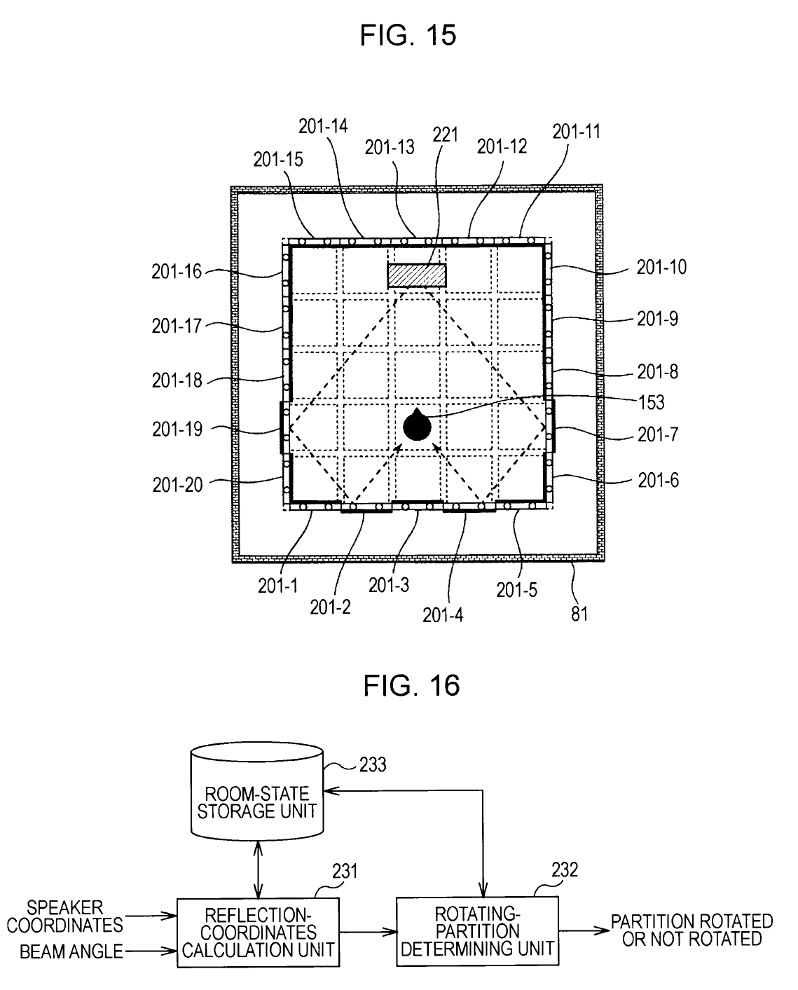

FIG. 15 is a view showing a specific example in which such a partition 201 with both side panels formed of materials having different reflectances is used. A speaker 221 set in a room shown in FIG. 15 is a speaker from which an output sound is directly given to a user 153, and which also gives sound to the user 153 from the back side by utilizing reflection by the wall. This speaker 221 is a speaker that realizes a system commonly called a surround-sound system. By using such a speaker 221, a stereo acoustic system can be offered to the user 153.

For example, part of the sound output from the speaker 221 impinges on a partition 201-7 and is reflected thereby, and the reflected sound is further reflected by a partition 201-4 and is given to the user 153 from the back side, as shown in FIG. 15. The reflected sound given to the user 153 after being reflected twice sounds to the user 153 as if the reflected sound was emitted from the back side. To realize this, it is preferable that a partition 201 set at a position to reflect sound efficiently reflect the sound. On the other hand, if a partition 201 set at a position where sound should not be reflected reflects the sound, the sound becomes noise. Hence, it is preferable that the partition 201 set at such a position do not reflect sound.

Accordingly, to efficiently reflect the sound, partitions 201 set at the positions to reflect the sound are set in a manner such that the panels 212 formed of the material that reflects sound point toward the user 153, and the other partitions 201 set at the positions where sound should not be reflected are set in a manner such that the panels 211 formed of the material that absorbs sound point toward the user 153. In the example shown in FIG. 15, a partition 201-2, a partition 201-4, a partition 201-7, and a partition 201-19 are set with panels 212 pointing toward the user 153, and the other partitions, that is, a partition 201-1, a partition 201-3, a partition 201-5, a partition 201-6, partitions 201-8 to 201-18, and a partition 201-20 are set with panels 211 pointing toward the user 153.

Next, a description will be given of a process for determining which of the panel 211 and the panel 212 is pointed toward the user 153. FIG. 16 is a view showing a configuration example of a processing unit that carries out the process for determining the panel to be pointed toward the user 153. The processing unit shown in FIG. 16 includes a reflection-coordinates calculation unit 231, a rotating-partition determining unit 232, and a room-state storage unit 233.

The reflection-coordinates calculation unit 231 calculates the coordinates of a position to reflect sound, from the coordinates of the speaker 221, the beam angle at which the speaker 221 outputs sound, and information stored in the room-state storage unit 233. The rotating-partition determining unit 232 specifies a partition 201 located at the coordinates of the position to reflect sound which is calculated by the reflection-coordinates calculation unit 231, and exerts control so that the panel 212 of the partition 201 points toward the user 153. Similarly to the room-state storage unit 182 shown in FIG. 10, the room-state storage unit 233 stores information about the room state, particularly, the coordinates of the partitions 201-1 to 201-20 and the panel surfaces pointing toward the user 153.

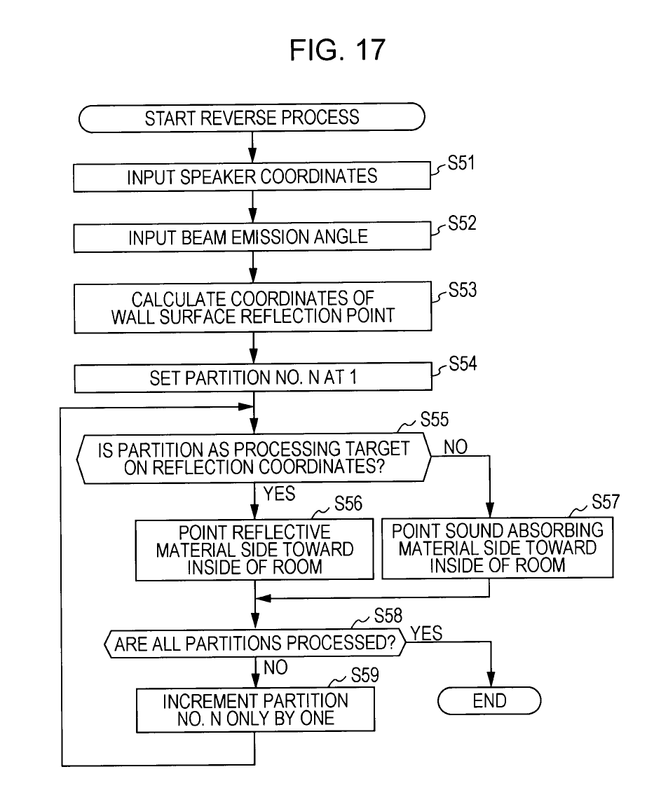

The process performed by the processing unit having this configuration will be described with reference to FIG. 17 serving as a flowchart. In Step S51, the coordinates of the speaker 221 are input to the reflection-coordinates calculation unit 231. Regarding to the coordinates of the speaker 221 and so on, as mentioned above in the description of Step S21, for example, one point in the room is set at the origin (0, 0) beforehand so that a predetermined position in the room can be expressed in coordinates.

In Step S52, the beam emission angle is input to the reflection-coordinates calculation unit 231. The beam emission angle refers to the direction in which a sound for spuriously reproducing a sound output from a rear speaker or the like is output when realizing a surround-sound environment with the speaker 221. That is, the beam emission angle refers to the direction in which a sound given as a reflected sound to the user 153 is output. Since this beam emission angle is shown in the instructions of the speaker 221 or the like or can be arbitrarily set by the user, the value shown in the instructions or the value arbitrarily set by the user is input.

In Step S53, the coordinates of a wall surface reflection point are calculated. The reflection-coordinates calculation unit 231 calculates the coordinates of a setting position of the partition 201, which is on a line extending to the wall 81 in the beam emission angle direction, from the coordinates of the speaker 221 and beam emission angle that are input. That is, the coordinates of the partition 201 that should reflect the sound are calculated.

In Step S54, the partition number N is set at 1. Similarly to the above, the partition number refers to a serial number assigned to each partition. When the partition number N is set at 1 in Step S54, a partition 201 to which the partition number N of “1” is assigned (partition 201-1 in this case) is set as a processing target. Then, operations in Step S55 and subsequent steps are conducted on the partition 201 set as the processing target.

In Step S55, it is determined whether or not the partition 201 serving as the processing target is a partition 201 on the reflection coordinates calculated in Step S53. When it is determined in Step S55 that the partition 201 serving as the processing target is a partition 201 on the reflection coordinates, the process proceeds to Step S56, where a panel 212 formed of a reflective material is pointed toward the user 153.

For example, when the partition 201 serving as the processing target is a partition 201-2 (FIG. 15), it is determined in Step S55 that the partition 201 serving as the processing target is a partition 201 on the reflection coordinates, and the process proceeds to Step S56, where control is exerted so that a panel 212 of the partition 201-2 is pointed toward the user 153.

In contrast, when it is determined in Step S55 that the partition 201 serving as the processing target is not a partition 201 on the reflection coordinates, the process proceeds to Step S57, where a panel 211 formed of a sound absorbing material is pointed toward the user 153.

For example, when the partition 201 serving as the processing target is a partition 201-1 (FIG. 15), it is determined in Step S55 that the partition serving as the processing target is not a partition 201 on the reflection coordinates, and the process proceeds to Step S57, where control is exerted so that a panel 211 of the partition 201-1 is pointed toward the user 153.

The determined panel surface is supplied to and stored in the room-state storage unit 233. In this way, the room-state storage unit 233 always stores the latest information.

In Step S58, it is determined whether or not processing of all partitions is completed. In this case, the determination is made by determining whether or not the partition number N is “20”. When it is determined in Step S58 that processing of all partitions is not completed, the process proceeds to Step S59.

In Step S59, the partition number N is incremented only by one, and the processing target is switched to the next partition 201. Then, operations in Step S55 and subsequent steps are repeated for the partition serving as the new processing target. By repeating the operations in Steps S55 to S59, the panel surfaces of the partitions 201 set in the room are adjusted.

In contrast, when it is determined in Step S58 that processing of all partitions is completed, the process shown in FIG. 17 is finished. When the process is finished, the partitions 201 in the room are set, for example, as shown in FIG. 15. By thus adjusting the panel surfaces, a sound directly given to the user 153, of sounds output from the speaker 221, is directly given, and a sound given to the user 153 after reflection is efficiently reflected by the influence of the reflective material of the panel 212, and is then given to the user 153. An unnecessary sound is absorbed by the influence of the sound absorbing material of the panel 211. It is therefore possible to offer a good surround-sound environment to the user.

That is, the surround-sound feeling of the surround-sound system utilizing reflection by the wall surface can be improved. Further, sound image localization can be made clearer than in the conventional method.

As well, in the above-described embodiments, for example, in the embodiment described with reference to FIG. 15, two dummy rear speakers are given as an example. However, the above-described channel number to which the present invention is applicable is not limited to only the case in which the number of dummy speakers is two. That is, the present invention can be applied to a plurality of channel numbers.

For example, when the guide 122 is provided in the ceiling 121 in the lattice form, as shown in FIG. 15, the partition 201 can be reversed at various positions. Hence, by controlling the reflection positions, sound absorbing positions, angles, and number of partitions, an arbitrary reflection space can be produced.

Next, a description will be given of a utilizing method for partitions 201 that enhances the acoustic effect when a speaker for radially outputting sound is used instead of the speaker 221 for realizing the surround-sound environment.

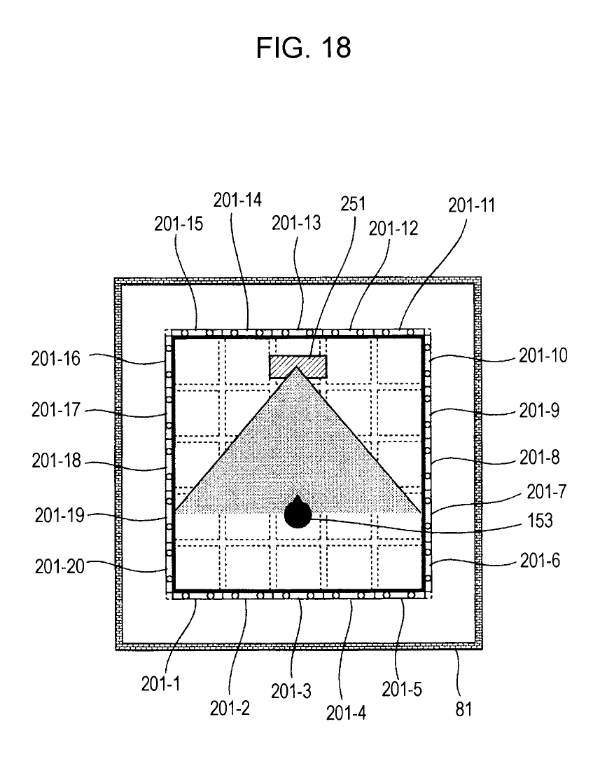

FIG. 18 shows an embodiment in which the partitions 201 shown in FIG. 14 are used and a speaker 251 for radially outputting sound and the partitions 201 each having two panels 211 and 212 shown in FIG. 14 are set in the room. In the embodiment shown in FIG. 18, the speaker 251 and a user 153 are surrounded by partitions 201-1 to 201-20, and the partitions 201-1 to 201-20 are all set with their panels 211 formed of a sound absorbing material pointing toward the user 153 (inside of the room).

By thus pointing the panels 211 formed of the sound absorbing material in all partitions 201-1 to 201-20 toward the inside of the room, sound output from the speaker 251 can be absorbed by the sound absorbing material. Thus, since a reflected sound can be reduced, the acoustic effect can be prevented from being lessened by the reflected sound.

As well, while the partitions 201 each include the panel 211 and the panel 212 in the embodiment shown in FIG. 18, since the panels 211 formed of the sound absorbing material in all the partitions 201-1 to 201-20 are pointed toward the inside of the room in this case, the panels of the partitions 201 themselves may be formed only of the sound absorbing material.

Next, a description will be given of an embodiment in which the acoustic effect is enhanced by concentrating a reflected sound at the user 153, without reducing the reflected sound by absorbing the sound. By concentrating the reflected sound at the user 153, a direct sound directly supplied from the speaker 251 and a plurality of concentrated reflected sounds can be given to the user 153, and the user 153 can have an audiovisual feeling different from that supplied when a direct sound and unconcentrated reflected sounds are given to the user 153.

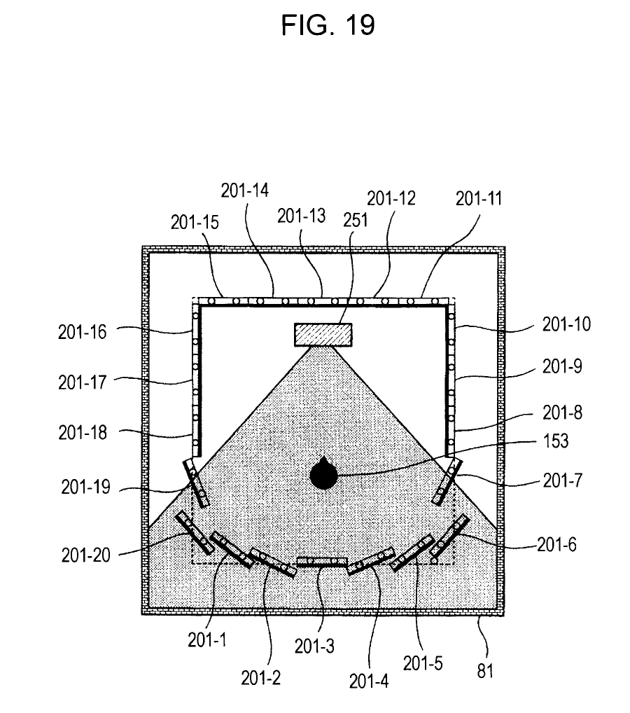

More specifically, referring to FIG. 19, the partitions 201 located on the front side of the user 153 point the panels 211 formed of the sound absorbing material toward the user 153, and the partitions 201 located on the back side of the user 153 (exactly, partitions 201 within the emission range of the speaker 251, which will be described in detail below) point the panels 212 formed of the reflective material toward the user 153. Further, the angles of the partitions 201 with the panels 212 pointed are adjusted so that reflected sounds therefrom concentrate at the user 153. A processing unit for adjusting the angles will be described.

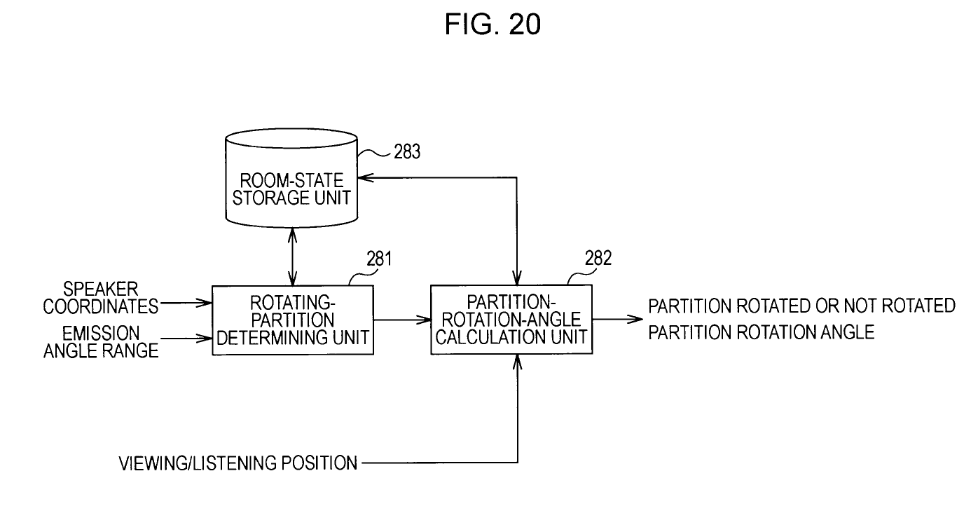

FIG. 20 is a view showing a configuration example of a processing unit that adjusts the angles. The processing unit shown in FIG. 20 includes a rotating-partition determining unit 281, a rotation-angle calculation unit 282, and a room-state storage unit 283. The rotating-partition determining unit 281 receives the speaker 251 and the emission angle of the speaker 251, distinguishes between partitions 201 located inside the emission angle and partitions 201 located outside the emission angle, and decides on the partitions 201 located inside the emission angle as partitions 201 to be rotated.

The rotation-angle calculation unit 282 calculates the rotation angles of the partitions 201 that are decided on to be rotated. The room-state storage unit 283 stores information about the room state, particularly, the coordinates of the partitions 201-1 to 201-20 and the panel surfaces pointed toward the user 153, similarly to the room-state storage unit 182 shown in FIG. 10 and the room-state storage unit 233 shown in FIG. 16.

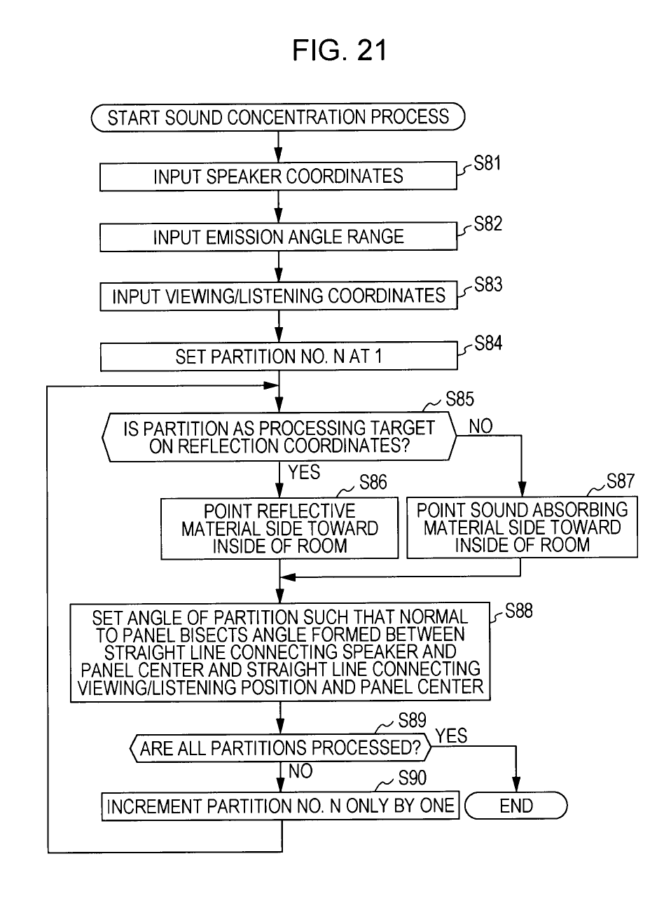

Next, a process performed by the processing unit shown in FIG. 20 will be described with reference to FIG. 21 serving as a flowchart. In Step S81, the coordinates of the speaker 251 are input to the rotating-partition determining unit 281. Regarding the coordinates of the speaker 251 and so on, for example, one point in the room is set at the origin (0, 0) beforehand so that a predetermined position in the room can be expressed in coordinates, as in the above description of Step S21.

In Step S82, the emission angle is input to the rotating-partition determining unit 281. The emission angle refers to the value that indicates the range in which sound output from the speaker 251 spreads forward. In FIG. 19, the emission angle is the angle of an apex of a diagonally shaded triangle. As the emission angle, for example, the value shown in the instructions of the speaker 251 or the like is input.

In Step S83, the coordinates of the viewing/listening position of the user 153 are input to the rotation-angle calculation unit 282.

In Step S84, the partition number N is set at 1. The partition number refers to a serial number assigned to each partition, similarly to the above description. When the partition number N is set at 1 in Step S84, a partition 101 to which the partition number N of “1” is assigned (partition 201-1 in this case) is set as a processing target. Then, operations in Step S85 and subsequent steps are conducted on the partition 201 set as the processing target.

In Step S85, it is determined whether or not the partition 201 serving as the processing target is a partition 201 on the reflection coordinates. The reflection coordinates are found by the rotating-partition determining unit 281. From the input coordinates and emission angle of the speaker, the rotating-partition determining unit 281 finds the coordinates included in the triangle diagonally shaded in FIG. 19 and a rectangular portion connected to the triangle. In actuality, however, it is only necessary to find the coordinates of a portion inside the partitions 201. In Step S85, it is determined whether or not the partition 201 serving as the processing target is present on the coordinates thus found.

When it is determined in Step S85 that the partition 201 serving as the processing target is a partition 201 on the reflection coordinates, the process proceeds to Step S86, where the partition 201 is set as a partition whose panel 212 formed of a reflective material is pointed toward the user 153.

For example, when the partition 201 serving as the processing target is a partition 201-1 (FIG. 19), it is determined in Step S85 that the partition 201 serving as the processing target is a partition 201 on the reflection coordinates, and the process proceeds to Step S86, where the partition 201 is set as a partition whose panel 212 is pointed toward the user 153.

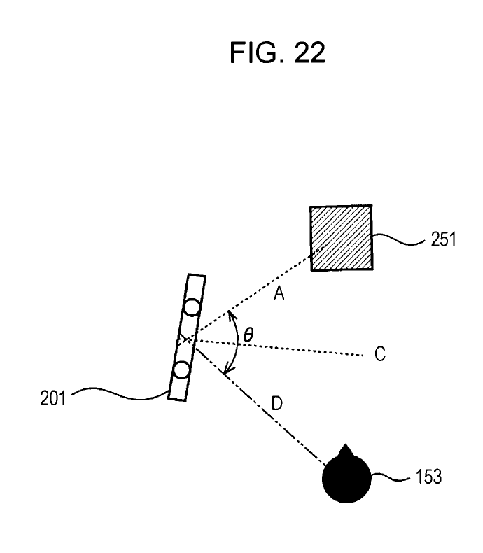

In Step S87, the angle of the partition 201, which is set as the partition whose panel 212 is pointed toward the user 153 in Step S86, is determined. This determination of the angle of the partition carried out in Step S87 will be described with reference to FIG. 22.

First, the angle (θ in FIG. 22) formed between a straight line connecting the speaker 251 and the center of the panel 212 of the partition 201 (a line shown by a dotted line A in FIG. 22) and a straight line connecting the viewing/listening position of the user 153 and the panel center (a line shown by a dotted line D in FIG. 22) is found. Then, the angle such that a normal to the panel (a line shown by a dotted line C in FIG. 22) bisects the angle θ is set as the angle of the partition 201 serving as the processing target.

In contrast, when it is determined in Step S85 that the partition 201 serving as the processing target is not a partition 201 on the reflection coordinates, the process proceeds to Step S88, where the panel 211 formed of the sound absorbing material is pointed toward the user 153.

For example, when the partition 201 serving as the processing target is a partition 201-8 (FIG. 19), it is determined in Step S85 that the partition 201 serving as the processing target is not a partition 201 on the reflection coordinates, and the process proceeds to Step S88, where control is exerted so that the panel 211 of the partition 201-1 is pointed toward the user 153.

The determined panel surface is supplied to and stored in the room-state storage unit 283. In this way, the room-state storage unit 283 always stores the latest information.

In Step S89, it is determined whether or not processing of all partitions is completed. In this case, determination is made by determining whether or not the partition number N is “20”. When it is determined in Step S89 that processing of all partitions is not completed, the process proceeds to Step S90.

In Step S90, the partition number N is incremented only by one, and a processing target is switched to the next partition 201. Then, operations in Step S85 and subsequent steps are repeated for the partition serving as the new processing target. By repeating the operations in Steps S85 to S90, the panel surfaces of the partitions 201 set in the room are adjusted.

In contrast, when it is determined in Step S89 that processing of all partitions is completed, the process shown in FIG. 21 is finished. When the process is finished, the partitions 201 are set in the room, for example, as shown in FIG. 19. By thus adjusting the panel surfaces, a sound directly given to the user 153, of sounds output from the speaker 251, is directly given, and sounds given to the user 153 after being reflected are efficiently reflected by the influence of the reflective materials of the panels 212, the reflected sounds are given to the user 153 in a concentrated state, and an unnecessary sound is absorbed by the influence of the sound absorbing materials of the panels 211. Hence, it is possible to give the user an audiovisual feeling different from a normal feeling, and to provide a good acoustic effect.

That is, by collecting only primary reflection at the viewing/listening position of the user 153, it is possible to produce an echoey sound field that cannot be experienced in the normal room (room that does not include partitions 201). Further, since the sounds can be concentrated at one point, even when the volume of reproduced sound is reduced, a physical feeling equivalent to that obtained when a loud sound is given can be offered to the user 153.

In the above-described embodiments, the partitions 201 are used to provide a good acoustic effect by efficiently reflecting and absorbing the sound. While the partitions 201 have the panels for that purpose, vibrating materials functioning as speakers or the like may be attached, instead of the panels. The present applicant has proposed, in Japanese Unexamined Patent Application Publication No. 2007-67538, a partition speaker apparatus that functions as a partition and also functions as a speaker.

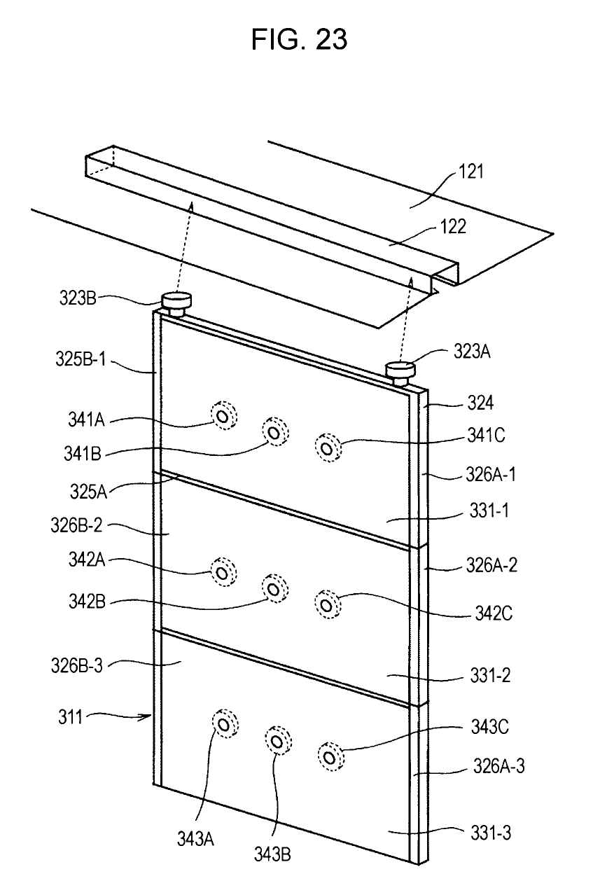

FIG. 23 is a view showing a configuration example of a partition speaker apparatus 311. The partition speaker apparatus 311 functions as a speaker, and also functions as a partition. The partition speaker apparatus 311 is supported with a wheel 323A and a wheel 323B being fitted in a guide 122 provided in a ceiling 121.

The partition speaker apparatus 311 includes the wheels 323A and 323B, a frame 324, plates 325A-1 to 325B-3, vibrating materials 331-1 to 331-3, and vibrators 341A to 343C.

The wheel 323A and the wheel 323B are fixed to the frame 324. The frame 324 includes a mechanism that fixes the vibrating materials 331-1 to 331-3 in a direction in which weight is applied (vertical direction), and the plates 325A-1 to 325B-3 that fix the vibrating materials 331-1 to 331-3 in the front-rear direction of the figure. The vibrating materials 331-1 to 331-3 are detachably fixed by their supports. The vibrating materials 331-1 to 331-3 are fixed in the vertical direction and the front-rear direction by the frame 324 and the plates 325A-1 to 325B-3.

Each of the vibrating materials 331-1 to 331-3 is shaped like a plate made of a material, for example, plasterboard, wood such as MDF (Medium Density Fiberboard), an aluminum plate, carbon, resin such as acrylic, or glass. Further, each of the vibrating materials 331-1 to 331-3 may be formed of a composite material in which different materials are combined (stacked).

To each of the vibrating materials 331-1 to 331-3, a plurality of vibrators (three vibrators in FIG. 23) are attached in a row in the figure. Vibrators 341A to 341C, vibrators 342A to 342C, and vibrators 343A to 343C are attached in a row in the figure to the vibrating material 331-1, the vibrating material 331-2, and the vibrating material 331-C, respectively.

For example, the vibrators 341A to 343C driven by a sound source such as an amplifier (not shown) vibrate the vibrating materials 331-1 to 331-3 according to sound signals input from the sound source, whereby the vibrating materials 331-1 to 331-3 output sounds. That is, the partition speaker apparatus 311 functions as a speaker that converts sound signals into sounds.

The vibrators 341A to 343C are detachably arranged at predetermined positions according to the vibration characteristics of the vibrating materials 331-1 to 331-3.

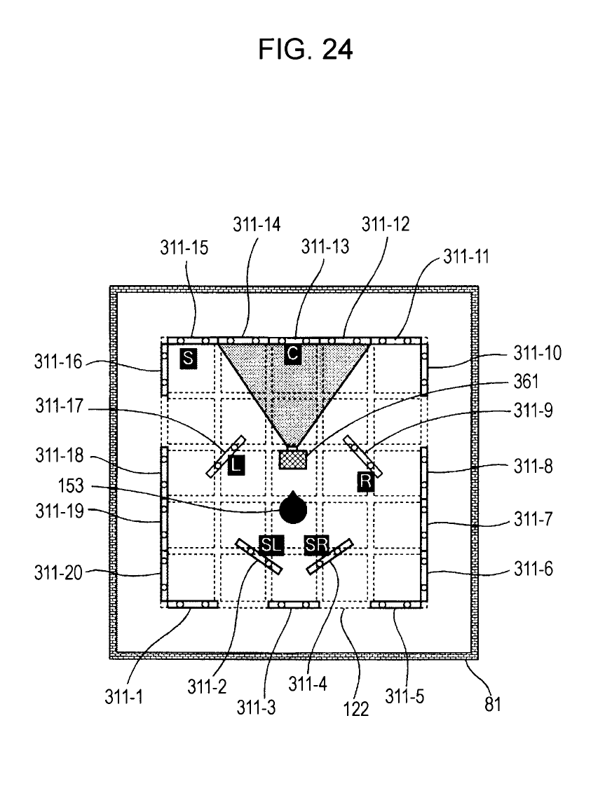

A description will be given of an embodiment in which a system called a 5.1-channel surround-sound system or the like is configured using such a partition speaker apparatus 311. FIG. 24 shows a layout of a room in which a projector 361 is set. A partition speaker apparatus 311-13 is set as a center speaker at a side toward which pictures are projected from the projector 361.

A partition speaker apparatus 311-9 and a partition speaker apparatus 311-17 are arranged as front speakers, respectively, on the right and left front sides of a user 153. Further, a partition speaker apparatus 311-2 and a partition speaker apparatus 311-4 are arranged as rear speakers, respectively, on the right and left rear sides of the user 153. Also, a partition speaker apparatus 311-15 is arranged as a subwoofer.

To obtain the maximum surround-sound effect with the surround-sound system, the speakers must be set at proper angles with respect to the viewing/listening position. Since the partition speaker apparatuses 311 have the structure shown in FIG. 23 and are movable along the guide 122, they can be set at proper angles necessary to obtain the maximum surround-sound effect. Hence, it is possible to offer the maximum surround-sound effect to the user 153.

As well, while a partition speaker apparatus 311-1, a partition speaker apparatus 311-3, partition speaker apparatuses 311-5 to 311-8, partition speaker apparatuses 311-10 to 311-12, a partition speaker apparatus 311-14, a partition speaker apparatus 311-16, and partition speaker apparatuses 311-18 to 20 in FIG. 24 each may be formed by the partition 311, for example, they each may be formed by the partition 201 shown in FIG. 14. When each of the partition speaker apparatuses is formed by the partition 201, the acoustic effect may be enhanced by pointing the panel 211 formed of the sound absorbing material toward the inside of the room so as to absorb unnecessary sounds.

Further, while the 5.1-channel surround-sound system is configured as an example in the description with reference to FIG. 24, the present invention is also applicable to other channel numbers. Since the partition speaker apparatus 311 functions as a speaker, as described above, for example, a 6.1-channel surround-sound system can be realized by using the partition speaker apparatus 311-3 in FIG. 24 as a center rear speaker.

Further, while, for example, the center speaker is formed by the partition speaker apparatus 311-13 in the description with reference to FIG. 24, the three partition speaker apparatuses 311, namely, the partition speaker apparatuses 311-12 to 311-14 may be center speakers. That is, one channel can be formed by a plurality of partition speaker apparatuses 311. The present invention can also properly respond to such system changes and system changes in accordance with the preference of the user only by a simple operation such as movement of the partition speaker apparatuses 311.

The present invention can be applied to surround-sound systems with various channel numbers.

As well, while the vibrating plates 331 are attached as the partition speaker apparatus 311 in the embodiment, different objects can be attached to the partition. For example, the partition speaker apparatus 311 can have a structure in which the vibrating plates 331 and a display are attached.

The application of the present invention can change the space of the room. Further, the application of the present invention can make the room shape symmetrical with respect to the speaker. Accordingly, it is possible to produce a space of the room that obtains an acoustic effect from which the influence of the furniture or the like set in the room is removed, for example, as described with reference to FIG. 8.

In addition, the application of the present invention can suppress reflection in the room and can prevent the acoustic effect from being lessened by an unnecessary standing wave. Further, it is possible to divide the sound output from the speaker into a part whose reflected sound is to be transmitted and a part whose reflected sound is not to be transmitted. For example, this can clarify the surround sound using the reflected sound. Further, by using the partition speaker apparatus 311 shown in FIG. 23, the speaker can be set at the position desired by the user, and a better acoustic space can be produced.

The above-described series of operations, for example, the operations performed by the processing unit shown in FIG. 10 can be carried out by hardware or carried out by software. When the series of operations are carried out by software, a program that forms the software is installed, from a program recording medium, into a computer incorporated in specialized hardware or, for example, a general-purpose computer in which various functions can be carried out by installing various programs.

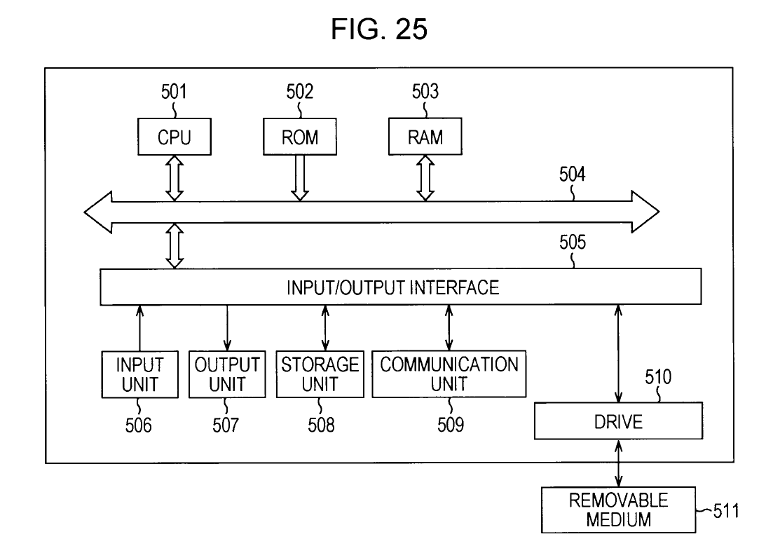

FIG. 25 is a block diagram showing a configuration example of hardware of a personal computer that carries out the above-described series of operations according to a program.

In the computer, a CPU (Central Processing Unit) 501, a ROM (Read Only Memory) 502, and a RAM (Random Access Memory) 503 are connected to one another by a bus 504.

An input/output interface 505 is further connected to the bus 504. To the input/output interface 505, an input unit 506 including a keyboard, a mouse, a microphone, etc., an output unit 507 including a display, a speaker, etc., a storage unit 508 including a hard disk, a nonvolatile memory, etc., a communication unit 509 including a network interface and so on, and a drive 510 for driving a removable medium 511, such as a magnetic disc, an optical disc, a magnetooptical disc, or a semiconductor memory, are connected.

In the computer having the above-described configuration, for example, the CPU 501 loads a program stored in the storage unit 508 into the RAM 503 via the input/output interface 505 and the bus 504 to execute the program, whereby the above-described series of operations are performed.

For example, the program executed by the computer (CPU 501) is recorded in the removable medium 511 serving as a package medium such as a magnetic disc (including a flexible disc), an optical disc (e.g., a CD-ROM (Compact Disc-Read Only Memory) or a DVD (Digital Versatile Disc)), a magnetooptical disc, or a semiconductor memory, or is offered via a wired or wireless transmission medium such as a local area network, the Internet, or digital satellite broadcasting.

Then, the program can be installed in the storage unit 508 via the input/output interface 505 by loading the removable medium 511 into the drive 510. Alternatively, the program can be received by the communication unit 509 via the wired or wireless transmission medium, and can be installed in the storage unit 508. Further alternatively, the program can be installed in the ROM 502 or the storage unit 508 beforehand.

As well, the program executed by the computer may be a program that performs processing in time series according to the order described in this specification, or may be a program that performs processing in parallel or at the required timing, for example, on demand.

Further, in this specification, the system indicates the entire apparatus constituted by a plurality of devices.

The embodiments of the present invention are not limited to the above-described embodiments, and various modifications can be made without departing from the gist of the present invention.

1. A partition comprising moving means and being set at each predetermined position that enhances an acoustic effect of sound output from an audio output device.

2. The partition according to claim 1,
wherein the audio output device is provided in a space formed by the partition, and
wherein the partition is set in a manner such that a distance from the audio output device to a predetermined side of the space is equal to a distance from the audio output device to the other side opposing the predetermined side.

3. The partition according to claim 1, wherein the partition is set in a manner such that the sound output from the audio output device is reflected a plurality of times.

4. The partition according to claim 1,
wherein one surface of the partition is a first surface formed of a material that absorbs sound, and the other surface of the partition is a second surface formed of a material that reflects sound,
wherein the partition is set in a manner such that the first surface points toward the audio output device when being set at a position to absorb the sound from the audio output device, and
wherein the partition is set in a manner such that the second surface points toward the audio output device when being set at a position to reflect the sound from the audio output device.

5. The partition according to claim 4,
wherein the audio output device outputs the sound in a beam form,
wherein the partition is set in a manner such that the second surface points toward the audio output device when being set at a position where the sound output in the beam form impinges, and
wherein the partition is set in a manner such that the first surface points toward the audio output device when being set at another position.

6. The partition according to claim 4,
wherein the audio output device outputs the sound radially,
wherein the partition is set in a manner such that the second surface points toward the audio output device when being set at a position where the radially output sound impinges, and
wherein the partition is set in a manner such that the first surface points toward the audio output device when being set at another position.

7. The partition according to claim 1, wherein the partition is set in a manner such that a surface which forms the partition and which is formed of a material that absorbs sound points toward the audio output device.

8. The partition according to claim 1, wherein the partition includes the audio output device, and is set as an audio output device that forms a surround-sound system.

9. The partition according to claim 1,
wherein the moving means is a wheel fixed to a lower side of the partition, and
wherein the partition further comprises tension fixing means that fixes the partition by contact with a ceiling.

10. The partition according to claim 9, further comprising second tension fixing means that fixes the partition by contact with a floor surface.

11. The partition according to claim 10, further comprising a rotation shaft to be loosely fitted in holes provided in the floor surface and the ceiling.

12. A control device comprising a control unit configured to control a setting position of a partition to be set at a predetermined position that enhances an acoustic effect of sound output from an audio output device,
wherein the control unit calculates an angle formed between a straight line connecting the audio output device and the partition, and a wall surface of a room where the audio output device is set, and controls setting of the partition so that a normal to the partition is located to bisect the angle.

13. A control method of a control unit configured to control a setting position of a partition to be set at a predetermined position that enhances an acoustic effect of sound output from an audio output device, the control method comprising the steps of:
calculating an angle formed between a straight line connecting the audio output device and the partition and a wall surface of a room where the audio output device is set; and
controlling setting of the partition so that a normal to the partition is located to bisect the angle.

14. A program readable by a computer that causes a control unit to perform processing,
wherein the control unit controls a setting position of a partition to be set at a predetermined position that enhances an acoustic effect of sound output from an audio output device, and
wherein the processing includes the steps of:
calculating an angle formed between a straight line connecting the audio output device and the partition, and a wall surface of a room where the audio output device is set; and
controlling setting of the partition so that a normal to the partition is located to bisect the angle.

15. A control device comprising a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device,
wherein, when the audio output device outputs the sound in a beam form, the control unit calculates coordinates of a position on a wall surface where the sound in the beam form impinges, from coordinates where the audio output device is set and a beam emission angle at which the sound in the beam form is output,
wherein the control unit exerts control so that the second surface points toward the audio output device when a partition serving as a processing target, of a plurality of partitions, is a partition on the coordinates of the position on the wall surface, and
wherein the control unit exerts control so that the first surface points toward the audio output device when the partition serving as the processing target is not the partition on the coordinates of the position on the wall surface.

16. A control method of a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device, the control method comprising the steps of:
calculating coordinates of a position on a wall surface where the sound in a beam form impinges, from coordinates where the audio output device is set and a beam emission angle at which the sound in the beam form is output when the audio output device outputs the sound in the beam form;
exerting control so that the second surface points toward the audio output device when a partition serving as a processing target, of a plurality of partitions, is a partition on the coordinates of the position on the wall surface; and
exerting control so that the first surface points toward the audio output device when the partition serving as the processing target is not the partition on the coordinates of the position on the wall surface.

17. A program readable by a computer that causes a control unit to perform processing,
wherein the control unit controls a setting position of a partition which has one surface serving as a first surface formed of a material that absorbs sound and the other surface serving as a second surface formed of a material that reflects sound and which is set at a predetermined position that enhances an acoustic effect of sound output from an audio output device, and
wherein the processing includes the steps of:
calculating coordinates of a position on a wall surface where the sound in a beam form impinges, from coordinates where the audio output device is set and a beam emission angle at which the sound in the beam form is output when the audio output device outputs the sound in the beam form;
exerting control so that the second surface points toward the audio output device when a partition serving as a processing target, of a plurality of partitions, is a partition on the coordinates of the position on the wall surface; and
exerting control so that the first surface points toward the audio output device when the partition serving as the processing target is not the partition on the coordinates of the position on the wall surface.

18. A control device comprising a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device,
wherein, when the audio output device radially outputs the sound, the control unit calculates coordinates of a position on a wall surface where the radially output sound impinges, from coordinates where the audio output device is set and a beam emission angle at which the radially output sound is output, exerts control so that the second surface points toward the audio output device when a partition serving as a processing target, of a plurality of partitions, is a partition on the coordinates of the position on the wall surface, and exerts control so that the first surface points toward the audio output device when the partition serving as the processing target is not the partition on the coordinates of the position on the wall surface.

19. The control device according to claim 18, wherein, when exerting control so that the second surface points toward the audio output device, the control unit calculates an angle formed between a first straight line connecting the audio output device and the partition and a second straight line connecting a user viewing/listening position to which the sound is supplied from the audio output device and the partition, and controls setting of the partition so that the second surface points in a direction in which a normal to the partition bisects the angle.

20. A control method of a control unit configured to control a setting position of a partition which has one surface serving as a first surface formed of a material that absorbs sound and the other surface serving as a second surface formed of a material that reflects sound and which is set at a predetermined position that enhances an acoustic effect of sound output from an audio output device, the control method comprising the steps of:
calculating coordinates of a position on a wall surface where the radially output sound impinges, from coordinates where the audio output device is set and a beam emission angle at which the radially output sound is output when the audio output device radially outputs the sound;
exerting control so that the second surface points toward the audio output device when a partition serving as a processing target, of a plurality of partitions, is a partition on the coordinates of the position on the wall surface; and
exerting control so that the first surface points toward the audio output device when the partition serving as the processing target is not the partition on the coordinates of the position on the wall surface.

21. A program readable by a computer that causes a control unit to perform processing,
wherein the control unit controls a setting position of a partition which has one surface serving as a first surface formed of a material that absorbs sound and the other surface serving as a second surface formed of a material that reflects sound and which is set at a predetermined position that enhances an acoustic effect of sound output from an audio output device, and
wherein the processing includes the steps of:
calculating coordinates of a position on a wall surface where the radially output sound impinges, from coordinates where the audio output device is set and a beam emission angle at which the radially output sound is output when the audio output device radially outputs the sound;
exerting control so that the second surface points toward the audio output device when a partition serving as a processing target, of a plurality of partitions, is a partition on the coordinates of the position on the wall surface; and
exerting control so that the first surface points toward the audio output device when the partition serving as the processing target is not the partition on the coordinates of the position on the wall surface.

22. A recording medium in which the program according to claim 1 is recorded.
